(19) United States
(12) Patent Application Publication
(10) Pub. No.: US 2017/0062093 A1
(43) Pub. Date: Mar. 2, 2017

(54) ELECTRICALLY CONDUCTIVE AND ELASTIC STRING

(71) Applicant: ASIATIC FIBER CORPORATION, Taipei City (TW)

(72) Inventor: Chun-Yen HUANG, Taipei City (TW)

(21) Appl. No.: 14/971,186

(22) Filed: Dec. 16, 2015

(30) Foreign Application Priority Data
Aug. 28, 2015 (TW) 104128261
Aug. 28, 2015 (TW) 104213969

(51) Int. Cl. H01B 3/50; A41D 1/00

(52) U.S. Cl. CPC H01B 3/50; A41D 1/005

(57) ABSTRACT

An electrically conductive and elastic string includes at least one elastic thread and at least one electrically conductive wire. The at least one elastic thread is elastically extendable in an extending direction. The at least one electrically conductive wire includes an inner electrically conductive core and an outer electrically insulating sheath surrounding and covering the inner electrically conductive core, extends sinuously along the at least one elastic thread in the extending direction, and connects with the at least one elastic thread, in such a way that the at least one electrically conductive wire is elastically extendable in the extending direction with the at least one elastic thread.

### CROSS-REFERENCE TO RELATED APPLICATION

This application claims priorities of Taiwanese Patent Application No. 104128261, filed on Aug. 28, 2015 and Taiwanese Utility Model Application No. 104213969, filed on Aug. 28, 2015.

### FIELD

The disclosure relates to a string, more particularly to an electrically conductive and elastic string.

### BACKGROUND

Commercially available electrically conductive strings used for electrical connection with electronic devices are generally designed without regard to compatibility with textiles, especially wearable textiles. When, incorporated in wearable textiles, the electrically conductive strings axe generally rather heavy and inelastic, causing the user to feel restricted in movement and inconvenienced by the presence of the attached object. With the development of smart textiles, an increasing number of electrically conductive strings are being incorporated in wearable textiles to achieve functions such as electrical signal transfer. Therefore, there is an emerging demand to provide electrically conductive strings that, when incorporated in wearable textiles, reduce the sensation of an attached foreign object on the user and are capable of elastically extending according to user movement.

### SUMMARY

Therefore, an object of the present disclosure is to provide an electrically conductive and elastic string that can alleviate at least one of the aforementioned drawbacks associated with the conventional electrically conductive strings.

According to an aspect of the present disclosure, an electrically conductive and elastic string includes at least one elastic thread and at least one electrically conductive wire. The at least one elastic thread is elastically extendable in an extending direction. The at least one electrically conductive wire includes an inner electrically conductive core and an outer electrically insulating sheath surrounding and covering the inner electrically conductive core, extends sinuously along the at least one elastic thread in the extending direction, and connects with the at least one elastic thread, such that the at least one electrically conductive wire is elastically extendable in the extending direction with the at least one elastic thread.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary schematic view showing a first embodiment of an electrically conductive and elastic string of the present disclosure;

FIG. 2 is a fragmentary schematic view showing the first embodiment being stretched;

FIG. 3 is a partly cross-sectional schematic view of the first embodiment, showing two adhesive threads, each of which extends with a respective one of the electrically conductive wires;

FIG. 4 is at fragmentary schematic view showing the first embodiment being electrically connected to two conductive elements;

FIG. 5 is a fragmentary schematic view showing the first embodiment being attached to an object and being stretched; and

FIG. 6 is a fragmentary schematic view showing a second embodiment of an electrically conductive and elastic string of the present disclosure.

### DETAILED DESCRIPTION

Before the disclosure is described in further detail with reference to the accompanying embodiments, it should be noted herein that like elements are denoted by the same reference numerals throughout, the disclosure.

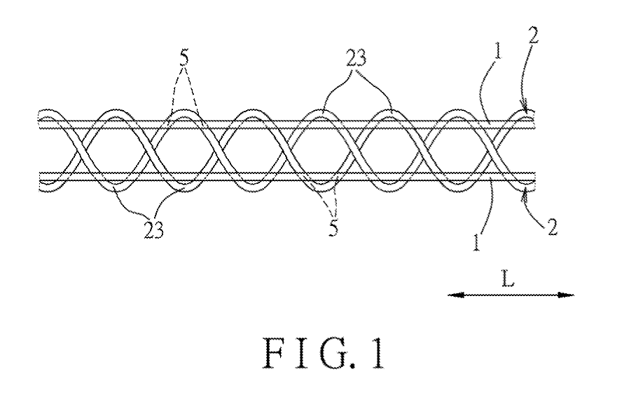

Referring to FIGS. 1 to 3, a first embodiment of an electrically conductive and elastic string of the present disclosure includes two elastic threads 1 and two electrically conductive wires 2.

The elastic threads 1 are spaced apart from and substantially parallel to each other, and extend along an extending direction (L). Each of the elastic threads 1 is made of an elastic material and is elastically extendable in the extending direction (L). Specifically, the elastic threads 1 are capable of being stretched when an external force is applied thereto, and are capable of restoring to an unstretched state when the external force is released. In certain embodiments, each of the elastic threads 1 includes a plurality of elastic fibers (not shown) that are twisted together.

Each of the electrically conductive wires 2 includes an inner electrically conductive core 21, and an outer electrically insulating sheath 22 surrounding and covering the inner electrically conductive core 21. The electrically insulating sheath 22 of one of the electrically conductive wires 2 prevents the one of the electrically conductive wires 2 from short circuiting when in contact with the other one of the electrically conductive wires 2 or other electrically conductive articles (not shown). The electrically conductive wires 2 extend sinuously and alternatingly along the elastic threads 1 in the extending direction (L). Each of the electrically conductive wires 2 alternatingly connects with the elastic threads 1 at contacting points 5 in such a way that the electrically conductive wires 2 are elastically extendable in the extending direction (L) with the elastic threads 1. In certain embodiments, each of the electrically conductive wires 2 alternatingly penetrates through the elastic threads 1.

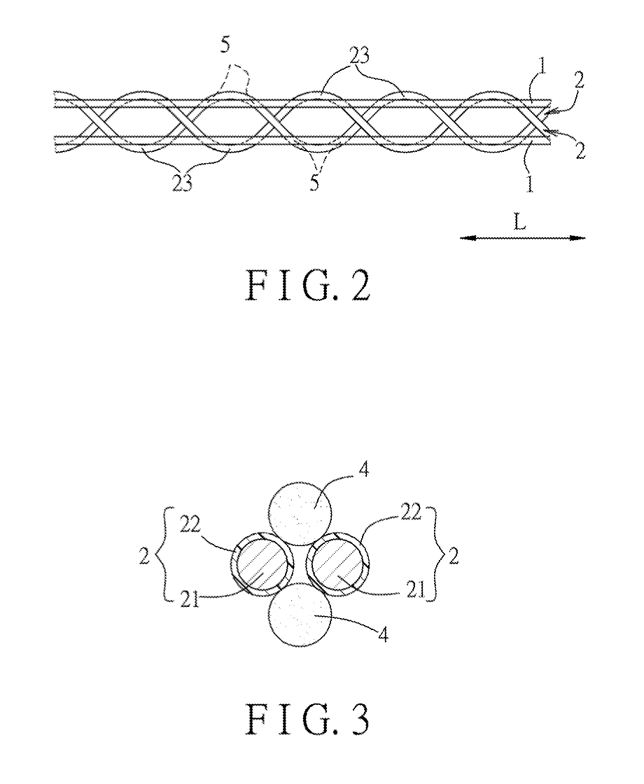

When the elastic threads 1 are stretched in the extending direction (L) by the external force, the electrically conductive wires 2 are extended in the extending direction (L) with the elastic threads 1, where the contacting points 5 are moved away from each other, and a plurality of arc portions 23 of the electrically conductive wires 2, each defined between adjacent two of the contacting points 5, are flattened (see FIG. 2). When the external force is released, the elastic threads 1 are restored to the unstretched state by its restoring force and thus the electrically conductive wires 2 are restored to an unextended state with the elastic threads 1, where the contacting points 5 are moved toward each other, and the arc portions 23 of the electrically conductive wires 2 are unflattened (see FIG. 1).

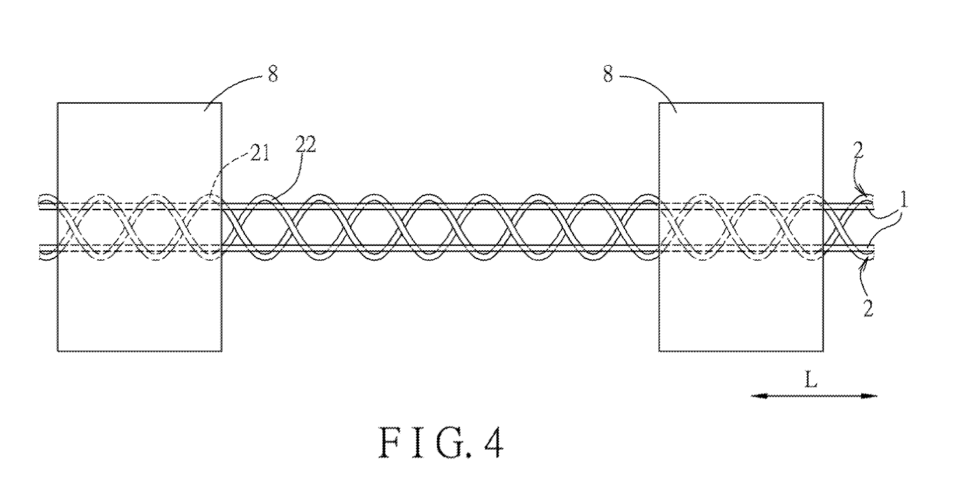

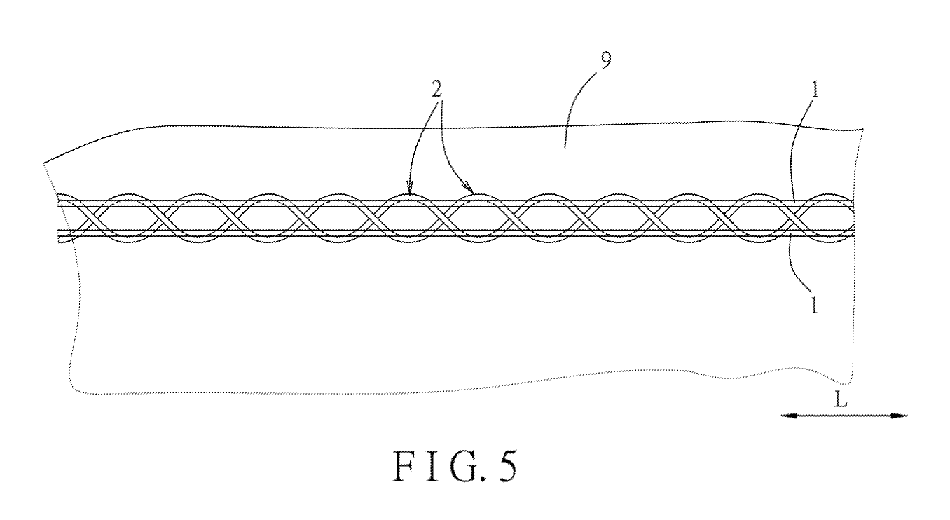

Referring to FIG. 4, in certain embodiments, physical or thermal treatment may be applied to each of the electrically conductive wires 2 to ablate a portion of the outer electrically insulating sheath 22 and expose a portion of the inner electrically conductive core 21. The exposed portions of the inner electrically conductive core 21 may be electrically connected to two conductive elements 8, e.g., electrode sheets. It should be noted that the number of the electrically conductive wires 2 may be changed according to the number of the conductive elements 8 and practical requirements.

In certain embodiments, the electrically conductive and elastic string may further include two adhesive threads 4 (see FIG. 3). Each of the adhesive threads 4 extends with a respective one of the electrically conductive wires 2 in a side-by-side manner. Each of the adhesive threads 4 may include a hot-melt adhesive that becomes adhesive when heated. Therefore, in certain embodiments, the electrically conductive and elastic string may be attached to a stretchable object by virtue of the adhesive threads 4. The elastic threads 1 and the electrically conductive wires 2 are elastically extendable in the extending direction (L) with the object 9. The object 9 may be an elastic textile that is a part of clothes worn by a user. Therefore, the electrically conductive and elastic string is elastically extendable with the movement and the body shape of the user.

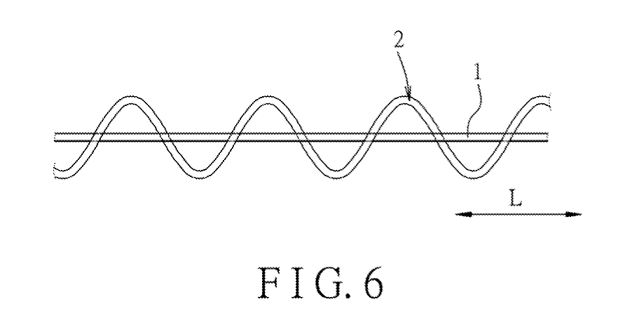

Referring to FIG. 6, a second embodiment of the electrically conductive and elastic string according to the present disclosure is similar to the first embodiment. In the second embodiment, the electrically conductive and elastic string includes one elastic thread 1 and one electrically conductive wire 2. The electrically conductive wire 2 extends sinuously along the elastic thread 1 in the extending direction (L), and connects with the elastic thread 1 in such a way that the electrically conductive wire 2 is elastically extendable in the extending direction (L) with the elastic thread 1. In certain embodiments, the elastic thread 1 includes a plurality of the elastic fibers (not shown) that are twisted together, and the electrically conductive wire 2 penetrates through the elastic thread 1 and extends sinuously in the extending direction (L). In certain embodiments, the electrically conductive and elastic string may further include one adhesive thread 4 (not shown) that extends with the electrically conductive wire 2 in a side-by-side manner.

It should be particularly pointed out that the numbers of the elastic threads 1 and the electrically conductive wires 2 of the electrically conductive and elastic string according to the present disclosure may vary based on practical requirements. Moreover, the manner in which the elastic threads 1 and the electrically conductive wires 2 are connected may also change according to actual needs, as long as the electrically conductive wires 2 are elastically extendable with the elastic threads 1.

To sum up, with the electrically conductive wires 2 connected to the elastic threads 1, the electrically conductive wires 2 can be elastically extendable with the elastic threads 1. Moreover, with the use of the adhesive threads 4, the electrically conductive and elastic string can be attached to the object 9, so that the electrically conductive and elastic string of this disclosure can be elastically extendable with the object 9.

While the disclosure has been described in connection with what axe considered the exemplary embodiments, it is understood that this disclosure is not limited to the disclosed embodiments and variation but is intended to cover various arrangements included within the spirit and scope of the broadest interpretation so as to encompass all such modifications and equivalent arrangements.

What is claimed is:

1. An electrically conductive and elastic string comprising:
at least one elastic thread that is elastically extendable in an extending direction; and
at least one electrically conductive wire that includes an inner electrically conductive core and an outer electrically insulating sheath surrounding and covering said inner electrically conductive core, that extends sinuously along said at least one elastic thread in the extending direction, and that connects with said at least one elastic thread, in such a way that said at least one electrically conductive wire is elastically extendable in the extending direction with said at least one elastic thread.

2. The electrically conductive and elastic string as claimed in claim 1, wherein said at least one elastic thread includes a plurality of elastic fibers that, are twisted together, and said at least one electrically conductive wire penetrates through said at least one elastic thread and extends sinuously in the extending direction.

3. The electrically conductive and elastic string as claimed in claim 1, wherein said electrically conductive and elastic string comprises two of said elastic threads that are spaced from each other, and said at least one electrically conductive wire extends sinuously along said elastic threads and alternatingly contacts with said elastic threads.

4. The electrically conductive and elastic string as claimed in claim 3, wherein said electrically conductive and elastic string comprises two of said electrically conductive wires that extend sinuously and alternatingly along said elastic threads in the extending direction, and each of said electrically conductive wires alternatingly contacts with said elastic threads.

5. The electrically conductive and elastic string as claimed in claim 4, further comprising two adhesive threads adapted for attaching said electrically conductive and elastic string to an object, each of said adhesive threads extends with a respective one of said electrically conductive wires.

6. The electrically conductive and elastic string as claimed in claim, 1, further comprising an adhesive thread adapted for attaching said electrically conductive and elastic string to an object, said adhesive thread extends with said at least one electrically conductive wire.
